(19) United States
(12) Patent Application Publication
(10) Pub. No.: US 2016/0071138 A1
(43) Pub. Date: Mar. 10, 2016

(54) ASSET REPOSITIONING

(71) Applicant: Lee HILL, Phoenix, AZ (US)

(72) Inventor: Lee HILL, Phoenix, AZ (US)

(21) Appl. No.: 14/840,378

(22) Filed: Aug. 31, 2015

Related U.S. Application Data
(60) Provisional application No. 62/046,376, filed on Sep. 5, 2014.

(51) Int. Cl. G06Q 30/02; G06Q 20/18; G06Q 30/06

(52) U.S. Cl. CPC G06Q 30/0208; G06Q 30/0645; G06Q 30/0641; G06Q 20/18

(57) ABSTRACT

A system and method is presented in which a mobile customer base is incentivized to reposition inventory in rental article-dispensing machine served areas. By utilizing the systems and methods presented herein, an effective increase in the utilization of existing inventory is realized thus making for an overall more efficient system. In part, the system and method entails providing incentive to a mobile customer base through the real time generation of alternative rental contracts during user interface interactions.

### FIELD

(1) Technical Field

The field of invention relates to systems and methods for the efficient repositioning of assets, such as a rental inventory which may comprise but not be limited to; handheld digital media content containing articles, digital video disks (DVDs), and/or video games, in rental article-dispensing machine, or, kiosk enabled provider-user rental transaction scenarios.

(2) Background Art

Currently, systems and methods are known where a user may interface with an article-dispensing machine in order to obtain a rental article, or, an asset from a provider of such rental services. In these rental transactions, a standard contract is generated in real time between the user and the provider to rent the article, or, asset for a period of time the length of which is usually left to the user's discretion. Users may typically return their rental article or articles to the same article-dispensing machine, or, alternatively, may return their rental article(s) to an alternate article-dispensing machine positioned at a different location from the location of the article-dispensing machine where the rental article was originally rented. The standard contract generated by the rental provider and accepted by the user may charge a fixed rate for every day a rental article is being rented, or, is in the possession or custody of the user. An invoice generated upon conclusion of the transaction, presumably at the time of the return of the rental article to an article-dispensing machine of the same provider, includes a total cost that is calculated based upon the length of time, for example, a specific number of days, that a rental article was rented for in a particular rental transaction as well as the number, type, and/or content of the rental article(s) themselves. The current methods and systems fail to incorporate, into the total cost of a transaction, value-affecting factors associated with the locations at which a user rents and returns the rental article and, if a plurality of rental articles are involved, the summation of location based value influencing factors for all of the rental articles in combination. Examples of the herein described provider-user rental transactional scenarios and descriptions of related and associated systems shall be herein described in more detail as set forth below.

U.S. Patent Application Publication Number 2012/0046786 describes a method for facilitating rapid return of an article to a rental article-dispensing kiosk. The application does not discuss repositioning rental articles. Additionally, U.S. Patent Application Publication Number 2012/0290423 describes a system and method for selling a rental media product. The method is described as providing an offer to sell a rental media product if a plurality of sales decision criteria are satisfied, and the system is described as vending a rental product from a vending apparatus to a user if the user accepts the offer for sale. The application also fails to mention repositioning the rental inventory. Furthermore, U.S. Pat. No. 8,060,247 describes a system and method for communicating secondary vending options for a vendible media product. The method is said to involve a vending controller at a vending location that receives a user request signal for a DVD. The system is said to then determine whether the DVD is available in a vending inventory at the vending location. The reference also does not mention repositioning the rental article.

Additionally, World Intellectual Property Organization Publication Number WO2013/012874 describes a system and method for providing the identification of geographically closest article-dispensing machines. While the reference may suggest providing a user with an alternate article-dispensing machine, it does not teach or suggest a scenario or transaction in which a user repositions a rental article.

Furthermore, World Intellectual Property Organization Publication Number WO2007/038839 discloses a vehicle rental system and method. The system and method are described for processing a transaction between a user and a rental vehicle provider. In use, the system is said to improve the ability to control the movements and/or distribution of rental vehicles between different depots so that, for example, adjustments in the number of rental vehicles located at each of the depots can be made in accordance with demand. The publication further describes a network in which a hub is communicatively coupled to multiple terminals for respective vehicle depots. The hub may be able to process depot status information for plural rental depots and use that information to influence the production of an agreement. For example, in one embodiment of the disclosure, a networked embodiment of a system may include means for identifying a rental provider preferred return depot (based on status information for the rental depots) to which a selected vehicle is to be returned at the end of a rental period and, further, to include, in an agreement, an incentive offer for the user to return the selected vehicle to that depot. By way of example presented in the publication, an incentive may include a reduction in the cost of the rental. The reference is limited to the description of vehicle rental transactions and does not describe a kiosk based rental environment for renting handheld, digital media content containing rental articles nor does the reference suggest rental transactions or scenarios wherein users rent multiple articles in a single rental transaction.

In U.S. Patent Application Publication Number 2002/0186144, a system and method for automating a vehicle rental process is described. The application describes an allocation manager system for geographically allocating vehicles. In one instance, the described method involves users in the redistribution of vehicles. Methods are presented to modify the demand curve for rental vehicles to prevent or reduce vehicle imbalances between locations. In one embodiment, the reference describes a system in which a rental vehicle provider offers incentives, for example, monetary incentives, to users for moving vehicles on behalf of the rental vehicle provider. This application is also limited to the description of vehicular rental transactions.

As such, systems and methods have been described for renting articles in article-dispensing kiosk environments as well as systems and methods for offering incentives for users to move vehicles on behalf of a provider. However there are distinct problems that arise in rental article kiosk based settings, scenarios, and transactions that are not addressed by solutions previously described as being suitable for rental transactions involving vehicles. The prior art fails to provide a solution for ensuring the return of a rental article to an alternate, preferable rental article-dispensing kiosk in order to, for example, satisfy a higher demand market or to lower overhead costs incurred by field operations support and logistics. The related disclosures also fail to provide a method to selectively reposition rental inventory where the rental inventory comprises handheld, digital media content containing articles, DVDs, and/or video games intended for subsequent rental and re-rental. The described references additionally fail to describe methods for repositioning a plurality of handheld rental articles in a single transaction and methods wherein a user provides the transportation necessary to reposition such handheld rental articles. The methods described in the references presented herein also fail to describe solutions for moving a selection of DVDs to an alternate rental article-dispensing kiosk based on stored user metadata. The publications further fail to describe methods and systems for offering an incentive to a user in real time that is expressed within an alternate contract, or, an agreement presented by a rental provider for acceptance by a user, that has been altered to include conditions providing for the return of a selected rental article, or, a plurality of selected rental articles to an alternate rental article-dispensing machine, or, kiosk. While references described herein do mention preferential repositioning of rental articles, those references are limited to the use of automobiles, or, vehicles as rental products, assets, or inventory to be repositioned. The references described herein further fail to describe systems and methods for providing a rental transaction wherein a desirable, beneficial, or optimal repositioning of at least one handheld, electronic, digital media content containing rental article is achieved through the assistance of a user, or, customer. These shortcomings of the prior are art are addressed in the systems, methods, and embodiments of the present invention as described, presented, and set forth herein.

### BRIEF SUMMARY OF THE INVENTION

While the present invention is often described herein with reference to a DVD distribution system, an application to which the present invention is advantageously suited, it will be readily apparent and appreciated that the systems and methods presented herein are not meant to be limited to that particular application. The systems and methods of the present invention are envisioned as be applicable in multiple article dispensing machine provider-user transactional scenarios and as being used in the repositioning of a wide variety of dispensable rental articles, or, any rental article or articles capable of being vended by or returned to an article-dispensing machine by a user.

Conventional stand-alone vending machines, also referred to herein as rental article dispensing machines, or, kiosks, are configured to store, dispense, and receive rental articles. They provide users, or, customers with an automated service that obviates the need of human assistance at the initial rental stage of the rental transaction process. Such dispensing machines typically store rental articles in discrete, identifiable locations. A selection process enables the user to select among a browse mode, a rent mode, and a return mode. An article selection feature enables the user to select at least one desired rental article to be vended, or, rented to the user through the article-dispensing machines by the rental service provider. The article-dispensing machines may preferably have a main graphical user interface comprising a touch screen with option display, user input detection, and output display capabilities. The rental article dispensing machines may also comprise a user interface having an article return slot for receiving rented articles such as DVDs contained within a case, or, video cassette sized complimentary to the slot for receiving rented articles being returned. The rental article-dispensing machine may further comprise a user interface capable of detecting and accepting a payment means, such as, for example, a credit card swipe, reader, or, any other payment means detecting sensor that is used for initiating the rental transaction, identifying a user, and/or beginning the payment portion of the rental process.

In one embodiment of the present invention a new, alternate rental contract may be presented to a user for consideration and/or acceptance. This new, alternate rental contract may include repositioning conditions that, when satisfied, result in realized incentives to a user, or, in the case of multiple transactions, to a customer base consisting of many users. Upon assent and execution of the alternate contract through the specific performance of relocating the at least one rental article by the user, both the provider and the user realize benefits. A renter, or, user receives an incentive and a provider obtains a relocation service from the renter, or, user who, without having been presented the alternate rental contract and the incentive contained therein, would typically and likely have returned the selected rental article or plurality of rental articles to the same rental article-dispensing machine. Among other benefits, the systems and methods presented herein effectively aid in the repositioning of rental inventory in higher demand areas thus increasing the utilization and profitability of individual units of existing inventory.

Furthermore, the systems and methods presented herein assist in resolving multiple problematic, or, non-desirable situations. Additional benefits may be realized upon implementation of the systems and methods of the present invention in a kiosk based rental environment. Some of the problematic situations that the herein described invention resolves include those in which, for example, a user uploads a “wish list” to a provider offered personal profile but wherein the “wish list” items are not readily accessible in kiosks in a close proximity to the user, unbalanced situations wherein a single rental-article dispensing machine contains an undesirably large amount of duplicative rental articles, which effectively limits the number of rental choices that a user may select from, situations where captured metadata but the extrapolated value from that metadata is not fully realized without utilization and implementation of the systems and methods of the present invention, other situations in which digital media content containing articles are not preferentially distributed or allocated amongst kiosks or user bases, ongoing situations wherein the supply and demand for a particular rental article fluctuates resulting in underutilization of existing inventory, situations resulting in undue and excessive provider incurred overhead costs commonly attributed to, or associated with, logistical content manipulation and manual movement of inventory, situations involving the unrestricted movement of rental inventory across city, county, state, or international borders, situations in which repositioning of a plural number of digital media content containing articles, such as DVDs, in a single rental transaction by a single user would be beneficial, situations wherein asset positioning may be predicted based on known or estimated customer rent or return dates and/or locations but wherein such knowledge does not otherwise provide value to a rental service provider, a general decrease in user satisfaction due to selected media content unavailability or stagnant inventory distributions, situations where known timings exist, such as those of upcoming trips of the user, but wherein knowledge of such timing information by the rental service provider is not otherwise used to add value for the provider, and, other situational transaction scenarios and settings herein described in greater detail. These examples are not meant to be limiting and the systems and methods of the present invention may otherwise add perceived or actual value to both providers of such rental goods and services as well as the customers, or, users of such rental goods and services.

### BRIEF DESCRIPTIONS OF THE FIGURES

FIG. 1 shows a flowchart representing a user kiosk interface transaction scenario.

FIG. 2 shows an option presented to a user to return a rental article to another location.

FIG. 3 shows an option presented to a user to select a zip code in which a rental article may be returned.

FIG. 4 shows an option presented to a user to select an alternate kiosk address for return.

FIG. 5 shows an option presented to a user to input upcoming trip locations and dates.

### DETAILED DESCRIPTION

Currently, there are systems and methods for renting and returning digital media articles through kiosks, or, article-dispensing machines that are dispersed throughout article-dispensing machine served markets. These digital media articles may consist of digital DVDs. It is within the contemplations of the present invention to incorporate and include all types of digital media that may be stored on a DVD. Forms and formats of data capable of being saved or stored on DVDs include multiple media forms such as: movies, video games, music and other forms known to those familiar with the art but not explicitly delineated in the herein described invention. These forms of digital media are not meant to be limiting and are meant to be included within the bounds of the current invention as are other articles that may not necessarily be vended in the form of a DVD containing video cassette.

The kiosks as herein described may contain at least three user interface portions. One of the user interface portions may consist of a touch screen wherein the touch screen is capable of recognizing a user input and interpreting the user input based on the area of the touch screen at which a user's finger makes contact. The touch screen first user interface may include a display function capable of providing a user with a multiplicity of options at multiple points during the user interface transaction scenario. The point of contact between a user's finger and the touch screen may determine which option a user has selected. In a preferred embodiment of the present invention, a user may be presented with an option to return an asset, or, digital entertainment media containing rental article to an alternate kiosk based on several factors or criteria, both on the side of the user and on the side of a provider, that a centralized computer system is capable of including in its computations and calculation in real time. The kiosk may contain a second manual user interface portion consisting of a vending or receiving portion where a user can obtain an asset device or return an asset to the kiosk. This second portion is usually in the form of a slot sized complimentarily to and for accepting and/or dispensing, for example, a DVD containing video cassette. It is further contemplated that a second interface portion may comprise a hand input area similar to a typical beverage or snack vending machine. A third user interface included on rental article dispensing machines of the present invention is comprises a credit card reader and is capable of reading credit cards or other encoded magnetic strip containing cards such as, for example, coupon and gift cards. The third user interface may also comprise a wireless interface capable of determining a user's identity, payment credentials, and/or other data wirelessly through and in communicable conjunction with, for example, radio-frequency identification signal omitting and/or receiving devices, Bluetooth™ enabled devices, Wi-Fi™ enabled devices, satellite communication enabled devices, and/or other near field or far field communication technology enabled device or devices or combinations thereof for signaling and receiving data and/or other information or otherwise.

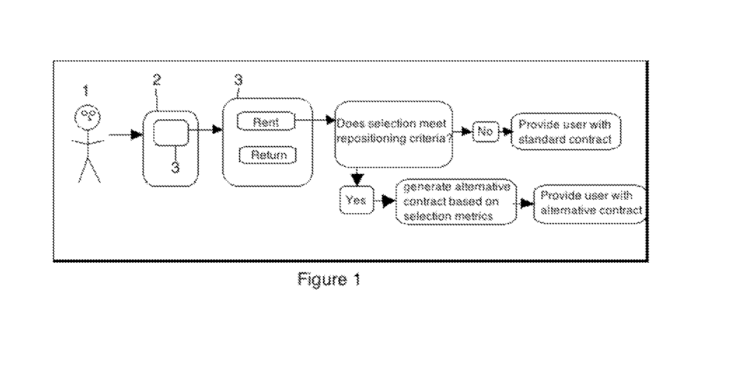

The methods and systems of the present invention effectively utilize a user base to reposition rental inventory consisting of digital or electronic entertainment media. A shown in FIG. 1, a user (1) may interface with a kiosk (2) at a touch screen first interface (3). The first interface (3) may present the user (1) with the option to rent or return a rental article. If the user selects that they desire to rent an article, then a system will calculate whether the selected rental article or plurality of selected rental articles meets a selection of repositioning criteria. If the selection does not meet the repositioning criteria, the touch screen first interface (3) will provide, by displaying such to the user (1), a standard rental contract. If the selected rental article or plural rental articles meets a set of repositioning criteria, then the user (1) will be provided with an alternate rental contract. The alternate rental contract's successful execution may be conditional upon the return of selected rental article or plural rental articles, such as entertainment media containing disks, to an article-dispensing machine different than the article-dispensing machine or kiosk (2) at which the rental article or plural rental articles were originally rented. Note, the alternate contract may include an “on-or-after” provision stating that the offer will only be valid if a user (1) adheres to a date or plurality of dates based restriction for returning said selected rental article or plural rental articles. Upon return of the rental article or plural rental articles to the different article dispensing machine, and adherence to any date restrictions and/or other conditional provisions, the alternate contract may be considered fully executed and a user (1) may have realized some incentive that was presented in the alternate contract. Non-limiting examples of such incentives include; reduction rental costs, reduction in future rental costs, vouchers or coupons for future rentals, credits or points that can accrue and be spent in a manner similar to credit card points or frequent flier miles, and preferred status with the provider which may make user (1) eligible for benefits he or she may otherwise not have been privileged to, two for one type deals or offers, as well as offers to businesses other than the rental provider but with whom the provider has an agreement with to allow for such cross-incentives to be offered to a user . It is further envisioned that said other business could have an address for a place of business at coordinates in close proximity to rental article dispensing machines but is not meant to be limiting.

During the point, in real time, at which a central system, said central system capable of being a computer or system of networked computers residing within or located separately from but in communication with article dispensing machine(s), computes and calculates whether or not to offer an alternate rental contract, several metrics, factors, and/or other variables associated with the selected rental article, the selected plurality of rental articles, and/or user related data will by taken into account by a computer algorithm programmed to decide whether or not to offer an alternate rental contract to the user. Non-limiting examples of such metrics, factors, and/or variables may include; current on-hand count of selected rental article(s) in the rental article dispensing machine at which the user originally rents the article, current on-hand count of selected rental article(s) in rental article dispensing machines different than but in a proximity to or having a significant geographical relational significance to the rental article dispensing machine at which the user originally rents the article, a last maximum out-of-rent value, a sold-out date value, a predicted or forecasted availability of selected rental article(s) at multiple kiosks and at multiple times, cost of rental article to provider, amortized or depreciated value of a selected rental article or plural rental articles, information or data on how a particular rental article or plurality of rental articles was or were obtained such as through revenue sharing agreements and license agreements with studios and game publishers, or through distributors or other suppliers as well as the dates of such agreements, information on whether or not a rental article is perceived as balanced with regards to its current rental article dispensing machine allocation and in comparison to that same rental article or plurality of rental articles at other rental article dispensing machines or the same for a like genre of rental article, predicted or forecasted supplies and demands for selected rental articles at different individual kiosks and/or combinations of related kiosks whether the relationship is geographic or proximity based or otherwise i.e., digitally created relationships based on stored metadata and/or other patterned or otherwise predictable temporal datasets, data based of the physical coordinates of a kiosk and space uptake, article dispensing machine specific inventory capacities and/or that of multiple proximal or otherwise related kiosks, public transportation data such as routes and/or timetables, other provider related data such as those associated with new releases, selection specific pre-DVD release data such as gross global box office revenue, selection specific pre-DVD release data such as geographic box office revenues, inventory planned phase-out data, labor, freight, maintenance and/or service schedule related data, other stored information or metadata that may include user frequented kiosks, user profile preferences, upcoming user input or uploaded travel plans, location specific information and historical rental data for that location, a user home address, average lengths of rental terms specific to a user, average lengths of rental terms specific to rental article machines and not user specific, or, a combination or statistical relation to an average length of rental for a specific user at a specific rental article dispensing machine or multiple rental article dispensing machines, entertainment content based historical rental data for a specific rental article dispensing machine or plurality of rental article dispensing machines, selected rental article specific historical rental information, and combinations thereof. The method may further provide an offer to reposition a selected rental article or multiple rental articles if a plurality of repositioning decision criteria are satisfied, and may vend a rental article from a second user interface portion capable of vending a selected digital media content containing rental article to a user if and when said user accepts the offer to reposition the rental article, or plurality of rental articles, on behalf of the provider. In making a determination on whether or not to offer the repositioning provision to the user, the computer system may further utilize a best fit equation to compute a or “trend” line. This gives a straight line that best represents related data in a series the values of which will vary along the series. Additionally, the computer system may utilize a threshold value calculation when determining whether to present the alternate rental contract to the user. Such a threshold value calculation will define upper and lower limits that will be used to determine whether the selection of rental articles meets a set of repositioning criteria. For example, if derivative value particular to a selection of rental article(s) surpasses a calculated threshold value, then the alternate rental agreement will be presented to the user and vice versa. It is envisioned that a liability waiver may be incorporated into an alternate contact so that a provider may mitigate risk and liability associated with and during the physical movement of selected rental article or multiple rental articles from an original rental article dispensing machine, at which a rental article was originally rented, to a different article dispensing machine. The above listed data types, variables, factors, metadata, and/or other rental scenario user and/or provider specific data that may be uploaded into said central system programmed for a specific set of algorithmic computations, calculations, and/or determinations, while herein delineated, are not meant to be limiting.

In a specific embodiment of the present invention having to do with the calculation determining whether or not an alternate contract offer will be provided to a user, specific attention may be paid to the occurrence of cases in which a plurality of digital media containing rental articles are requested by a user in a single transaction. It is contemplated that central system, such as a computer, network of computers, or combination thereof, will determine an independent threshold value for each selected rental article and then compute a calculation based on the combined values for each of the individual rental article. Thus, a weighted result will be taken into account for the final determination of whether or not to provide user with an alternate contract and, if so, the weighted result will be taken into account by said central system to further determine the specific provisions and/or conditions that will be included in the alternate contract, said alternate contract having been generated and offered for acceptance by user in real time, being specific to that particular user interface transaction or scenario. It is also envisioned in methods and systems of the present invention that a user may be provided with the option to return a selected rental article or plurality of rental articles at the time of return, not the time of rental. That is, a user could be offered an incentive to return a rental article or plurality of rental articles to a different rental article dispensing machine, if for example, the rental article dispensing machine is at full inventory capacity and unable to accept additional inventory or if repositioning said selected rental article or plurality of rental articles would otherwise be of or provide some value to a provider.

Typically, rental articles will consist of electronically stored media or multimedia although this is not limiting and the content library, also herein collectively referred to as assets, may consist of movies and video games available for rent or purchase. While the preferred embodiment of the present invention entails the renting of a multimedia entertainment content containing rental articles, other rental articles are also envisioned. For example, other rental articles could include various objects wherein an effective increase in efficiency or realized benefit to a user and/or a provider could be realized if a user is capable of returning the rental article to an alternate location and saving the provider from having to incur the costs of doing so.

Direct operating costs that are currently and normally incurred by a provider and could be reduced and/or altogether avoided by implementation of the preferred systems and methods of the present invention include those associated with the logistical handling of inventories of media content and specifically those associated with field operations support such as field technician labor compensation and benefits, other overhead such as insurance associated therewith, gas, freight and other shipping costs, as well as vehicle purchase, operating, and maintenance costs. In addition to the methods and systems of the present invention providing benefit to a provider of rental goods and services, a user will also find appreciation from the realization of the incentive present in the alternate rental contract agreement. The methods of the present invention will also realize an increase in the use of existing inventory by repositioning said rental article inventory assets in a manner such that the rental article itself will spend more time during its lifecycle in a users possession, generating revenue, as opposed to remaining stored in a kiosk for long periods of time. Furthermore, it has been noticed that rental inventories within kiosks are beginning to include older yet high demand movies and video games and are beginning to resemble A-Z libraries of the rental article selections that more closely resemble the rental selection of a store-front type digital media rental provider. The methods and systems of the present invention will be well suited to assist in repositioning or rental assets to achieve such described preferred rental article allocation, positioning, and repositioning.

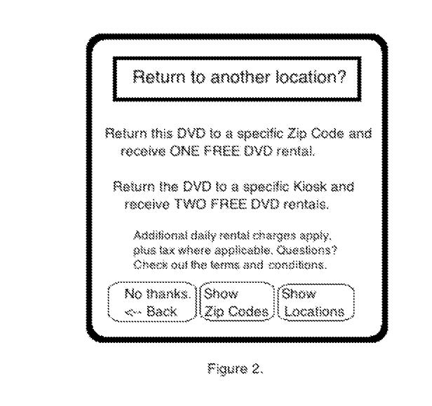

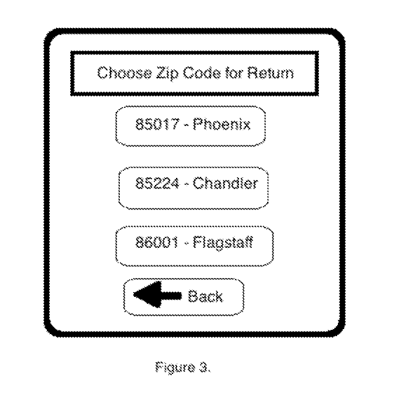

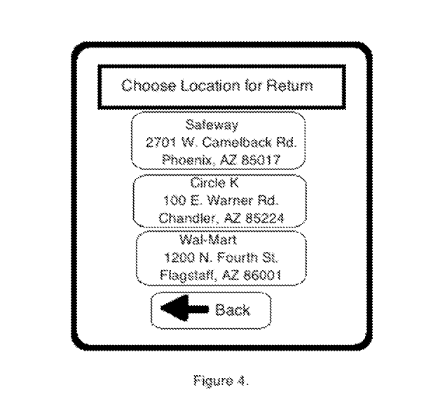

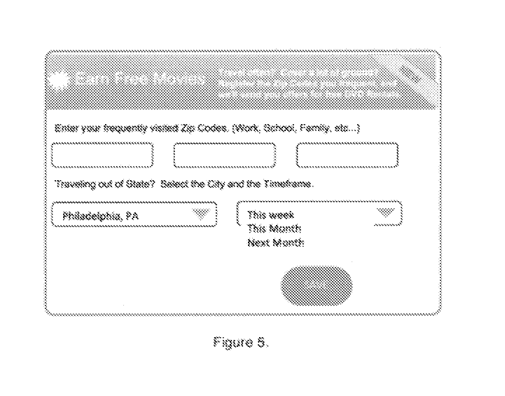

As is shown in FIG. 2, a user is provided, through display on a touch screen first user interface, with an option to return a rental article to a separate location. The user is also given an option to return a selected rental article to a specific zip code in exchange for one free DVD rental. The user is also provided with the option to return the rental article to a specific kiosk in exchange for two free DVD rentals. A further method of the present invention, as illustrated in FIG. 3, provides a user an option to choose from a selection of zip codes for rental article repositioning. The user, in this embodiment, is given the option to select between three zip codes wherein a DVD, other rental article, or plurality of rental articles is to be returned. The invention is further described in FIG. 4, which also shows a display on a touch screen first user interface wherein a user has been provided with the option to choose between three specific kiosk locations for subsequent return of a rental article selection. As is shown in FIG. 5, a user has been given an option to input his or her travel plans so that when a central system makes a decision to offer a user with an alternate rental contract, said alternate rental contract including rental article repositioning conditions, said central system may take into account a user's travel plans and incorporate those data when making a final alternate offer calculation and determination.

While this specification contains many particulars, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, it is understood that variations and enhancements may be made.

What is claimed is:

1. A rental system and method comprising:
a user;
a first kiosk for storing, dispensing, and receiving rental articles;
at least one second kiosk for storing, dispensing, and receiving rental articles; and
a computer network,
wherein the first and at least one second kiosks connect to the computer network and further comprise:
first user interfaces comprising touch screen displays configured to a detect user inputs and display options; and
second user interfaces comprising openings configured to dispense or receive rental articles,
and wherein the first kiosk:
detects an input from the user at the first user interface detailing a selection indicative of a request to rent at least one rental article; and
displays an option via its first user interface comprising an alternate rental agreement,
and further wherein the alternate rental agreement comprises a term or condition stipulating that the user may return the at least one rental article to the at least one second kiosk in exchange for an incentive.

2. A system and method of claim 1 wherein the at least one rental article comprises a handheld, digital media content containing, electronic device.

3. A system and method of claim 1 wherein the at least one rental articles comprises a DVD, a blu-ray disk, a video game containing disk, or combinations thereof.

4. A system and method of claim 1 wherein the first and at least one second kiosks communicate with the computer network to determine whether the at least one rental article meets a set of repositioning criteria.

5. A system and method of claim 1 wherein a computer of the computer network computes at least one equation, algorithm, calculation, or combination thereof to determine whether the at least one rental article meets a set of repositioning criteria.

6. A system and method of claim 5 wherein the computation includes at least one variable value particular to:
the at least one rental article;
the user;
at least one other user;
the first kiosk for storing, dispensing, and receiving rental articles;
the at least one second kiosk for storing, dispensing, and receiving rental articles;
at least one point in time related to the rental transaction;
and combinations thereof.

7. A system and method of claim 5 wherein the equation comprises a best fit equation.

8. A system and method of claim 5 wherein the calculation comprises a threshold value calculation.

9. A method for facilitating rental transactions in a kiosk based rental environment, the method comprising the steps of:
receiving, from a user at a first kiosk, a request to rent at least one handheld, digital media content containing, electronic device;
cross-referencing the request with a set of repositioning criteria; and
presenting an offer to the user to return the at least one handheld, digital media content containing, electronic device to at least one second kiosk in exchange for an incentive.

10. A method of claim 9 wherein the return of the device to at least one second kiosk constitutes an execution of offer by the user and entitles the user to the incentive.

11. A method of claim 9 further comprising a step in which a determination is made on whether to present the offer to the user.

12. A method of claim 11 wherein the step in which the determination is made comprises at least one computation of at least one equation, algorithm, other calculation, or a combination thereof.

13. A method of claim 12 wherein the at least one equation, algorithm, other calculation, or combination thereof incorporates at least one variable value particular to a rental transaction.

14. A method of claim 13 wherein the at least one variable value comprises at least one metric, data point, derivative value, or a combination thereof particular to:
at least one handheld, digital media content containing, electronic device;
the user;
at least one other user;
the first kiosk;
the at least one second kiosk;
at least one point in time related to the rental transaction;
and combinations thereof.

15. A system and method of claim 1 wherein the incentive is at least one selected from the group consisting of: a reduced rental cost, a free rental period, vouchers or coupons, credits or points, a preferred user status or designation, a benefit the user was not otherwise entitled to, two for one type deals or offers, discount offers to businesses other than a rental provider, and combinations thereof.

16. A method of claim 9 wherein the incentive is at least one selected from the group consisting of: a reduced rental cost, a free rental period, vouchers or coupons, credits or points, a preferred user status or designation, a benefit the user was not otherwise entitled to, two for one type deals or offers, discount offers to businesses other than a rental provider, and combinations thereof.

17. A system and method of claim 1 wherein the offer further comprises a provision that includes length of time, the duration of which defines a period that the offer will remain open for optional acceptance by the user.

18. A method of claim 9 wherein the offer further comprises a provision that includes length of time, the duration of which defines a period that the offer will remain open for optional acceptance by the user.
